(19) United States
(12) Patent Application Publication
(10) Pub. No.: US 2017/0168981 A1
(43) Pub. Date: Jun. 15, 2017

(54) SPI Interface With Slave-Select Fault Detection And Status Signal

(71) Applicant: Microchip Technology Incorporated, Chandler, AZ (US)

(72) Inventors: Kevin Kilzer, Chandler, AZ (US); Shyamsunder Ramanathan, Tucson, AZ (US); Sai Karthik Rajaraman, Chandler, AZ (US); Justin Milks, Tempe, AZ (US)

(73) Assignee: Microchip Technology Incorporated, Chandler, AZ (US)

(21) Appl. No.: 15/373,391

(22) Filed: Dec. 8, 2016

Related U.S. Application Data
(60) Provisional application No. 62/265,213, filed on Dec. 9, 2015.

(51) Int. Cl. G06F 13/42; G06F 13/40; G06F 13/364

(52) U.S. Cl. CPC G06F 13/4282; G06F 13/364; G06F 13/404

(57) ABSTRACT

A serial peripheral interface (SPI) module includes a transceiver including a clock line, a data line and at least one slave select line. The module also includes an interface circuit configured to monitor the slave select line and assert a fault based upon an incorrect de-assertion of the slave select line.

### RELATED PATENT APPLICATION

This application claims priority to commonly owned U.S. Provisional Patent Application No. 62/265,213; filed Dec. 9, 2015; which is hereby incorporated by reference herein for all purposes.

### TECHNICAL FIELD

The present disclosure relates to synchronous serial interfaces, in particular, a serial peripheral interface (SPI) with a slave-select fault detection and status signal.

### BACKGROUND

Synchronous serial peripheral devices use separate data and clock lines, wherein a data is synchronously transmitted with the clock signal. The devices are common interface peripherals in microcontrollers. They may also be used in a plurality of stand-alone devices, such as analog-to-digital converters, digital-to-analog converters, sensor devices, transmitters and receivers and any other type of device that needs to communicate with or within a microprocessor or microcontroller.

### SUMMARY

Some embodiments of the present disclosure include a serial peripheral interface (SPI) module which may include a transceiver including a clock line, a data line and at least one slave select line. The module also may include an interface circuit configured to monitor the slave select line and assert a fault based upon an incorrect de-assertion of the slave select line. In combination with any of the above embodiments, the fault may be stored in a status or control register. In combination with any of the above embodiments, the module may include a configuration register defining the number of bits per transmission. In combination with any of the above embodiments, the interface circuit may be further configured to assert a fault based upon a de-assertion of the slave select line before an expected number of bits is received at the module from a master module. In combination with any of the above embodiments, the interface circuit may be further configured to assert a fault based upon a de-assertion of the slave select line after more than an expected number of bits is received at the module from a master module. In combination with any of the above embodiments, the interface circuit may be further configured to assert a fault based upon a noisy slave select line. In combination with any of the above embodiments, the module may further include a counter configured to store an expected number of bits. In combination with any of the above embodiments, the interface circuit may be configured to decrement the counter upon a received bit. In combination with any of the above embodiments, the interface may be configured to assert a fault based upon a de-assertion of the slave select line when the counter is nonzero. In combination with any of the above embodiments, the module may be configured to operate in hardware while receiving parameters for operation through software, the parameters including a number of bits to be expected during transmission.

Embodiments of the present disclosure include a microcontroller or a processor including any of the modules described above.

Embodiments of the present disclosure include a method of operating any of the microcontrollers, processors, or modules described above. A method may include receiving data through a clock line, a data line and at least one slave select line, monitoring the slave select line, and asserting a fault based upon an incorrect de-assertion of the slave select line. In combination with any of the above embodiments, the method may further comprise storing the fault in a status or control register. In combination with any of the above embodiments, the method may further comprise storing, in a configuration register, the number of bits per transmission. In combination with any of the above embodiments, the method may further comprise asserting a fault based upon a de-assertion of the slave select line before an expected number of bits is received at the module from a master module. In combination with any of the above embodiments, the method may further comprise asserting a fault based upon a de-assertion of the slave select line after more than an expected number of bits is received at the module from a master module. In combination with any of the above embodiments, the method may further comprise asserting a fault based upon a noisy slave select line. In combination with any of the above embodiments, the method may further comprise storing an expected number of bits in a counter. In combination with any of the above embodiments, the method may further comprise decrementing the counter upon a received bit. In combination with any of the above embodiments, the method may further comprise asserting a fault based upon a de-assertion of the slave select line when the counter is nonzero.

### BRIEF DESCRIPTION OF THE FIGURES

FIG. 1 illustrates an example system 100 with components utilizing SPI interfaces, according to embodiments of the present disclosure;

FIG. 2 illustrates a timing diagram of operation of a slave interface, according to embodiments of the present disclosure;

FIG. 3 illustrates another timing diagram of operation of a slave interface, according to embodiments of the present disclosure;

FIG. 4 illustrates a timing diagram of operation of a slave interface with respect to a slave select fault signal, according to embodiments of the present disclosure;

FIG. 5 illustrates another timing diagram of operation of a slave interface with respect to a slave select fault signal, according to embodiments of the present disclosure;

FIGS. 6 and 7 illustrate more detailed timing diagrams of the relationship between the slave select signal and the slave clock signal, according to embodiments of the present disclosure; and

FIG. 8 illustrates an example method for identifying a fault associated with a slave select signal, according to embodiments of the present disclosure.

### DETAILED DESCRIPTION

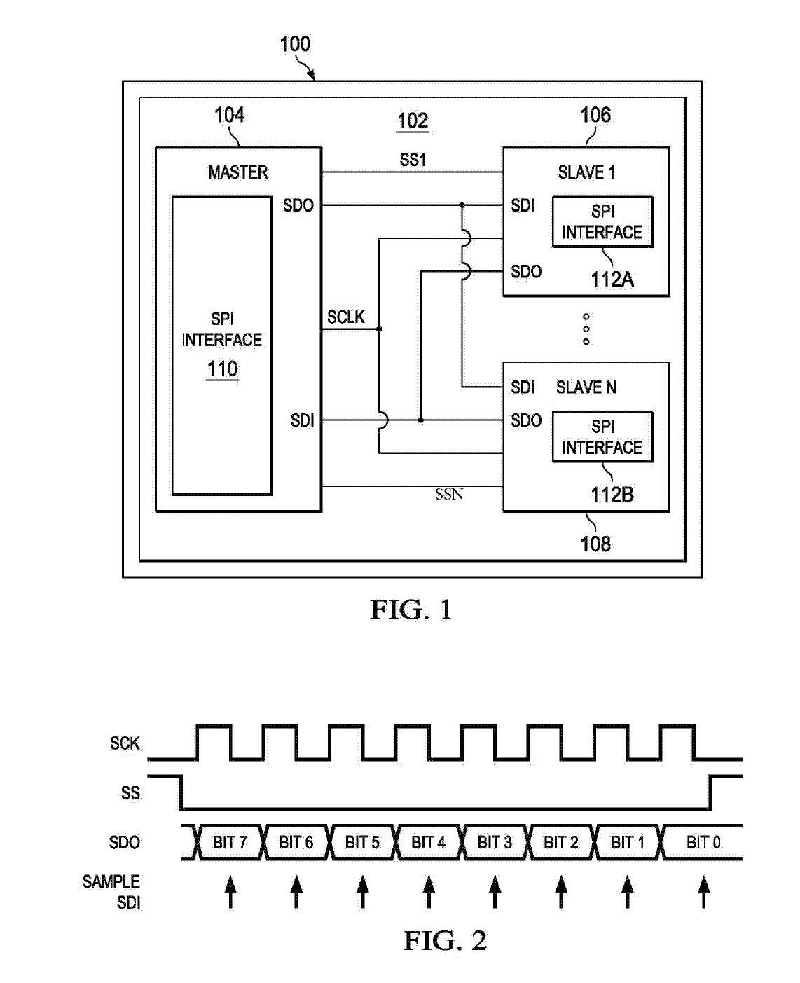

FIG. 1 illustrates an example system 100 with components utilizing SPI interfaces, according to embodiments of the present disclosure. In one embodiment, the components using SPI interfaces may use an SPI interface with slave select fault detection. In a further embodiment, the components receiving a slave select signal may identify faults with the slave select signal based upon a count of data that has been received. In another, further embodiment, the components receiving a slave select signal may identify a fault in the slave select signal if the slave select signal is de-asserted when an unexpected amount of data has been received since the slave select signal was first asserted.

SPI transfers data serially between multiple devices. The serial output data is changed on a particular slave clock edge and the data is sampled on the next slave clock. The slave transfers data when its slave select is asserted. For controlling the flag, the interfaces may comprise a transfer counter and a complex clock generation state machine according to some embodiments.

For example, system 100 may include a component that will communicate with other components as an SPI-protocol master, such as master 104. System 100 may include one or more other components that will communicate with master 104, such as slave 106 and slave 108. System 100 may include any suitable number and kind of components. For example, each of master 104, slave 106, and slave 108 may implement one or more analog-to-digital converters, peripherals, digital-to-analog converters, sensor devices, transmitters and receivers and any other type of device that needs to communicate with or within a microprocessor or microcontroller. Furthermore, although certain elements of system are so-designated as a master or slave elements according to the SPI protocol, any such elements might be configurable as either a master or a slave element according to an initialization by system 100. Thus, in one example, element 104 might be configured as an SPI master and element 106 might be configured as an SPI slave, but in different example, element 104 may be configured as an SPI slave in communication with element 106 which may be configured as an SPI master. Moreover, although two elements 106, 108 are illustrated as configured as slave elements, system 100 may include any suitable number of slave elements to communicate with master 104. Elements 104, 106, 108 may be built within a common die, device, or other mechanism, such as a microcontroller 102.

Master 104 may be communicatively coupled to slaves 106, 108 in any suitable manner. For example, master 104 may be communicatively coupled to each of slave 106, slave 108 through separate serial data-out (SDO) lines and separate slave select (SS) lines. Master 104 may be communicatively coupled to each of slave 106, slave 108 through separate or common clock (SCLK) and serial data-in (SDI) lines. SDO lines may be used to issue data from master 104 to a given slave 106 or slave 108. SDI lines may be used to issue data from slave 106 or slave 108 to master 104. SCLK lines may be used to synchronize operations between the elements. SS lines may be used by master 104 to command individual slave elements 106, 108 that they are to wake up and receive or sense data.

Each of elements 104, 106, 108 may communicate via respective interfaces, such as interface 110, interface 112A, and interface 112B. Interface 110 may be configured to allow master 104 to communicate with slave units, and interfaces 112A, 112B may be configured to allow slaves 106, 108 to communicate with master 104. Interfaces 110, 112A, 112B may be implemented by any suitable combination of digital logic, analog circuitry, and digital circuitry.

In some cases, from the perspective of slave 106 or slave 108, it is difficult to determine if an SPI data transfer has completed normally or not. An incomplete data transmission can corrupt a data transfer protocol, and expose subtle software bugs. Such faults arise, for example, when master 104 is unexpectedly disconnected or reset. This might be caused by hardware or software problems.

In one embodiment, slave interfaces 112A, 112B may detect a slave select fault by comparing respective slave select inputs and SDI lines against bit and byte counters included therein. Slave interfaces 112A, 112B may generate a fault condition indicator if the counters indicate an unexpected count of data between an assertion and de-assertion of the slave select line. In a further embodiment, slave interfaces 112A, 112B may be configured to set counters with an expected count of bits or bytes upon assertion of a slave select signal from master 104. Subsequently, slave interfaces 112A, 112B may be configured to count-down the counters as data arrives from master 104. Upon de-assertion of the slave select signal from master 104, slave interfaces 112A, 112B may be configured to determine whether the counters have reached zero. If the counters are at zero, then the expected number of bits or bytes have been received. Otherwise, too many or too few data have been received and slave interfaces 112A, 112B may generate an indicator that a fault has occurred.

The counts of the expected data for the counters may be set by software. The configuration of system 100 may be established through software parameters. Once configured through software, interfaces 106, 108 may operate in hardware. Depending on the protocol between master and slave, software will set the byte counter to some value, and the counter decrements with each received byte. When master and slave agree on the byte count and the module is correctly programmed, the counter will be zero when the SS signal de-asserts. If the master sends too few bytes, the counter will be some positive number (say, 1); if the master sends too many bytes, the counter will be some negative number.

FIG. 2 illustrates a timing diagram of operation of a slave interface, according to embodiments of the present disclosure. The interface checks for data and slave select signals each period of the slave clock. After assertion of the slave select signal (in this example, when slave select is low) by the master, SDI signals arrive, providing the data for each of eight bits. Upon completion of transfer of the eight bits, the slave select signal may de-assert (in this example, when slave select is high).

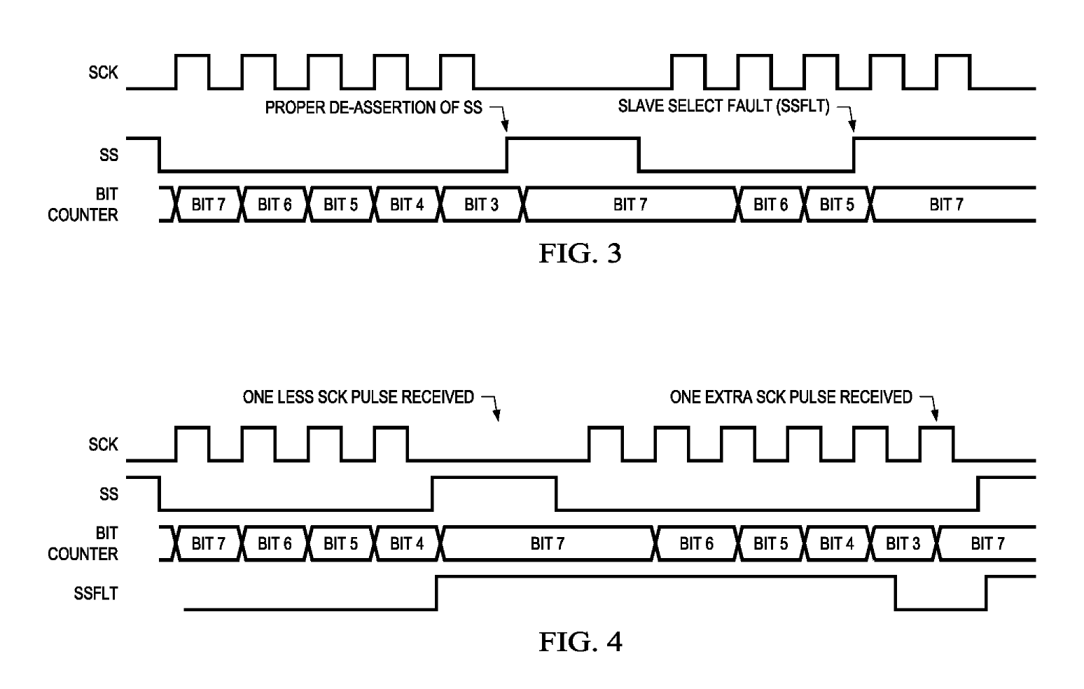

FIG. 3 illustrates another timing diagram of operation of a slave interface, according to embodiments of the present disclosure. In FIG. 3, five bits might be expected. After assertion of the slave select signal and receipt of five bits, the slave select signal might de-assert. In some embodiments, the slave clock might be discontinued during this time. Later, the slave signal might be asserted again to transmit another five bits. However, after receipt of only three bits, the slave select signal might be de-asserted. This may be premature, as only three, rather than five, bits have been asserted. Accordingly, the slave interface may generate a slave select fault (SSFLT) as a result. Similarly, the slave interface may generate such a fault if too many bits were received.

FIG. 4 illustrates a timing diagram of operation of a slave interface with respect to a slave select fault signal, according to embodiments of the present disclosure. In FIG. 4, five bits may be expected. The slave select signal may assert, and then four bits are received. However, before a fifth bit is received, the slave select signal may de-assert. Accordingly, the slave interface may raise the slave select fault indicator. The failure may have arisen from, for example, failure of the slave clock to have issued a signal when the last bit was to be received. Thus, only four bits might have been received. At a subsequent time, after a fifth bit has already been received, another slave clock signal might be received before the slave select de-asserts, triggering acquisition of a sixth bit. This may cause generation of the slave select fault signal.

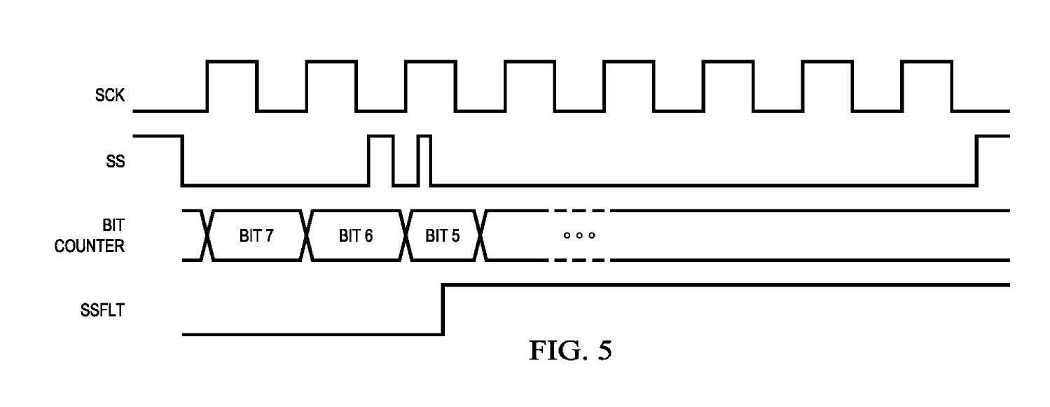

FIG. 5 illustrates another timing diagram of operation of a slave interface with respect to a slave select fault signal, according to embodiments of the present disclosure. In FIG. 5, the slave select signal may be affected by noise in the system. This may de-assert and then assert slave signal before all expected bits arrive at the interface. Upon such a condition, the slave select fault signal may be generated.

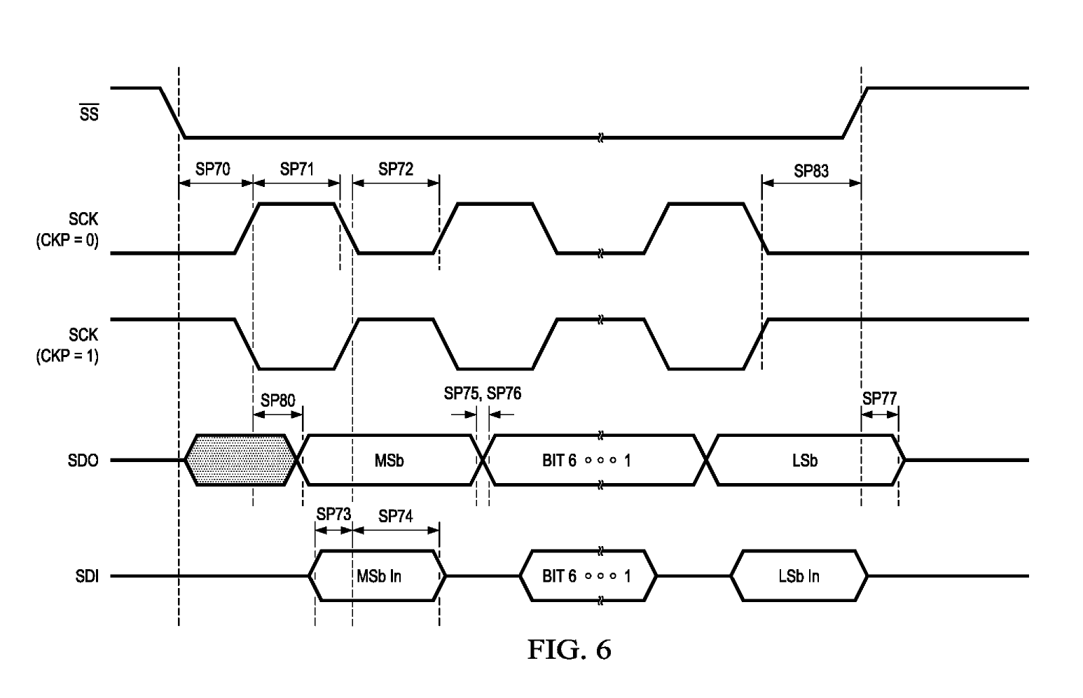

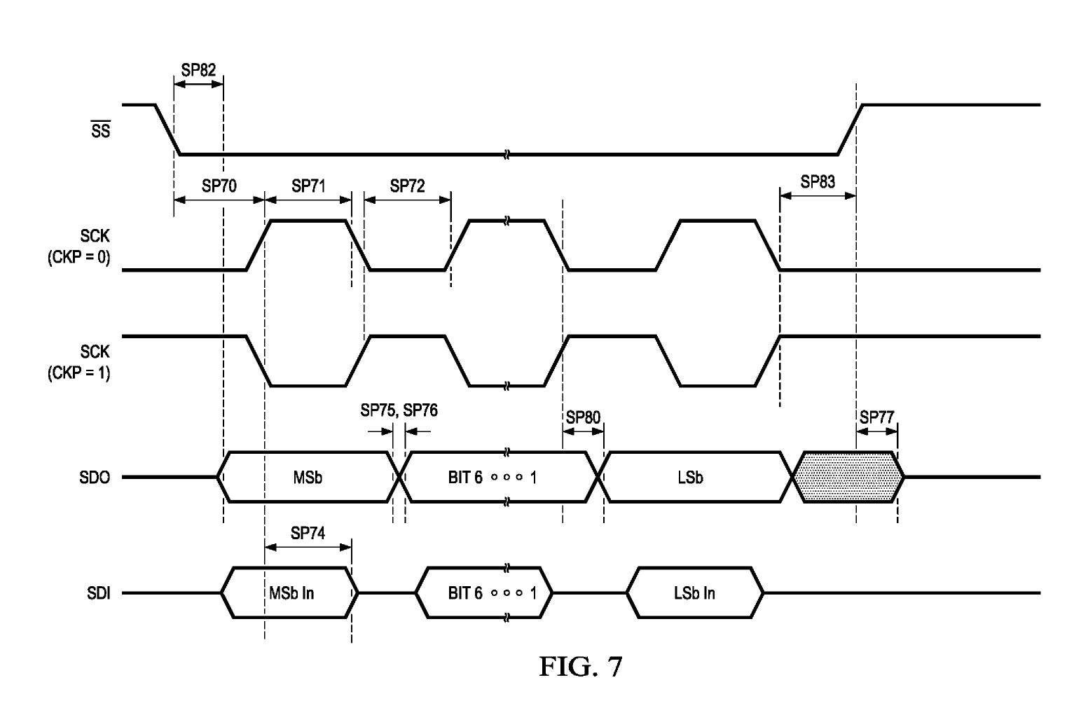

FIGS. 6 and 7 illustrate more detailed timing diagrams of the relationship between the slave select signal and the slave clock signal, according to embodiments of the present disclosure. The value of the slave select fault signal may be read by software accessing microcontroller 102 upon the trailing edge of the slave select signal. This may be performed through an associated interrupt. In some embodiments, the counter may actually decrement at the leading edge of the last slave clock pulse. In such a case, additional logic may be used to verify that the slave select does not change during the wrong slave clock state. Because the byte counter is only decremented at the final slave clock of a byte, a bit counter is implicitly included in the slave select fault test.

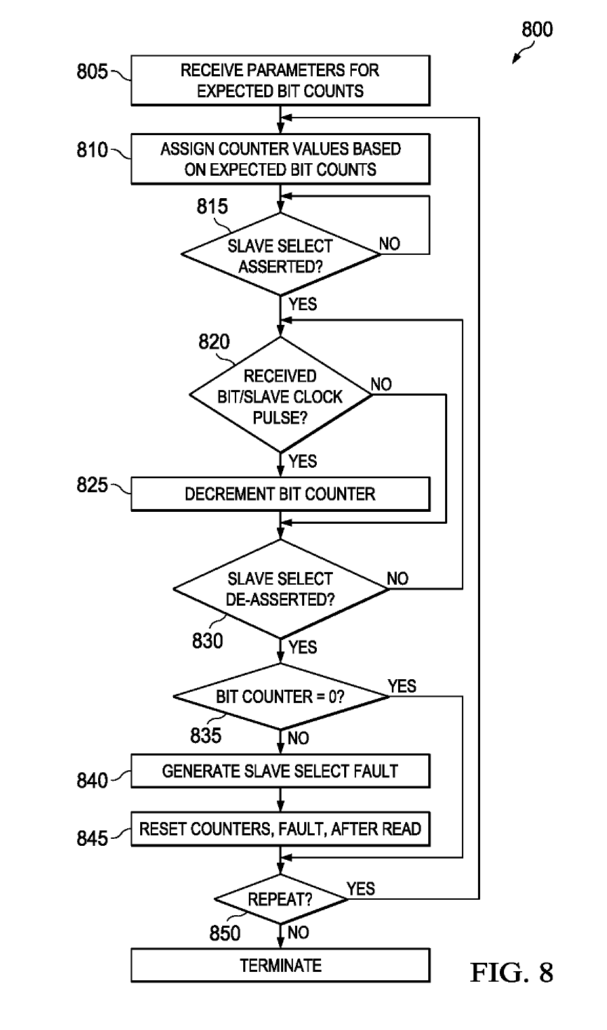

FIG. 8 illustrates an example method 800 for identifying a fault associated with a slave select signal, according to embodiments of the present disclosure.

At 805, parameters for operation of a slave interface may be set by, for example, software operations upon a microcontroller. The slave interface parameters may be set at the same time as other parameters for other slaves and a master are set. The parameters may specify how many bits or bytes are to be received in a single transfer between slave and master elements.

At 810, counter values may be set according to the expected bit or byte counts received from the operating parameters. These may be stored in, for example, a register. A slave interface may begin operation and wait for a slave select signal.

At 815, it may be determined whether a slave select signal has been asserted or received at the slave interface. If not, method 800 may repeat 815 and continue waiting. Otherwise, method 800 may proceed to 820.

At 820, it may be determined whether a bit or byte has been received, or whether a slave clock pulse has been received. If not, method 800 may proceed to 830. Otherwise, method 800 may proceed to 825.

At 825, the counter may be decremented.

At 830, it may be determined whether the slave select signal has been de-asserted. If so, method 800 may proceed to 835. Otherwise, method 800 may return to 820.

At 835, the value of the counter may be determined. If the counter is equal to zero, then transfer may have been made successfully and method 800 may proceed to 850. Otherwise, at 840 a slave select fault may be generated. At 845, after the fault has been read, counters may be cleared and the fault may be cleared.

At 850, it may be determined whether transfers will still be made. If so, method 800 may return to 810. Otherwise, method 800 may terminate.

Method 800 may be implemented by any suitable mechanism, such as by system 100 and the elements of one or more of FIGS. 1-7. In particular, method 800 may be performed by a slave interface. Method 800 may optionally repeat or terminate at any suitable point. Moreover, although a certain number of steps are illustrated to implement method 800, the steps of method 800 may be optionally repeated, performed in parallel or recursively with one another, omitted, or otherwise modified as needed. Method 800 may initiate at any suitable point, such as at 805.

Although example embodiments have been described above, other variations and embodiments may be made from this disclosure without departing from the spirit and scope of these embodiments.

1. A serial peripheral interface (SPI) module, comprising:
a transceiver including a clock line, a data line and at least one slave select line; and
an interface circuit configured to monitor the slave select line and assert a fault based upon an incorrect de-assertion of the slave select line.

2. The SPI module according to claim 1, wherein the fault is stored in a status or control register.

3. The SPI module according to claim 1, further comprising a configuration register defining the number of bits per transmission.

4. The SPI module according to claim 1, wherein the interface circuit is further configured to assert a fault based upon a de-assertion of the slave select line before an expected number of bits is received at the module from a master module.

5. The SPI module according to claim 1, wherein the interface circuit is further configured to assert a fault based upon a de-assertion of the slave select line after more than an expected number of bits is received at the module from a master module.

6. The SPI module according to claim 1, wherein the interface circuit is further configured to assert a fault based upon a noisy slave select line.

7. The SPI module according to claim 1, further comprising a counter configured to store an expected number of bits.

8. The SPI module according to claim 1, further comprising a counter configured to store an expected number of bits, wherein the interface circuit is configured to decrement the counter upon a received bit.

9. The SPI module according to claim 1:
further comprising a counter configured to store an expected number of bits; and
wherein the interface circuit is configured to:
decrement the counter upon a received bit; and
assert a fault based upon a de-assertion of the slave select line when the counter is nonzero.

10. A microcontroller, comprising:
a transceiver including a clock line, a data line and at least one slave select line; and
an interface circuit configured to monitor the slave select line and assert a fault based upon an incorrect de-assertion of the slave select line.

11. A method for evaluating serial peripheral interface communication, comprising:
receiving data through a clock line, a data line and at least one slave select line;
monitoring the slave select line; and
asserting a fault based upon an incorrect de-assertion of the slave select line.

12. The method according to claim 11, further comprising storing the fault in a status or control register.

13. The method according to claim 11, further comprising storing, in a configuration register, the number of bits per transmission.

14. The method according to claim 11, further comprising asserting a fault based upon a de-assertion of the slave select line before an expected number of bits is received at the module from a master module.

15. The method according to claim 11, further comprising asserting a fault based upon a de-assertion of the slave select line after more than an expected number of bits is received at the module from a master module.

16. The method according to claim 11, further comprising asserting a fault based upon a noisy slave select line.

17. The method according to claim 11, further comprising storing an expected number of a bits in a counter.

18. The method according to claim 11, further comprising:
storing an expected number of a bits in a counter; and
decrementing the counter upon a received bit.

19. The method according to claim 11, further comprising:
storing an expected number of a bits in a counter;
decrementing the counter upon a received bit; and
asserting a fault based upon a de-assertion of the slave select line when the counter is nonzero.
